(19) United States
(12) Patent Application Publication
(10) Pub. No.: US 2015/0039994 A1
(43) Pub. Date: Feb. 5, 2015

(54) COLOR-BASED DESIGNS

(71) Applicant: Designln, Inc., Marblehead, MA (US)

(72) Inventor: Ramsay Hoguet, Marblehead, MA (US)

(21) Appl. No.: 14/254,092

(22) Filed: Apr. 16, 2014

Related U.S. Application Data
(63) Continuation-in-part of application No. 14/029,266, filed on Sep. 17, 2013.
Application No. 14/029,266 is a continuation of application No. PCT/US2011/028848, filed on Mar. 17, 2011.
(60) Provisional application No. 61/812,714, filed on Apr. 16, 2013.
(60) Provisional application No. 61/813,171, filed on Apr. 17, 2013.

(51) Int. Cl. G09G 5/06; G06F 17/22

(52) U.S. Cl. CPC G09G 5/06; G06F 17/2247
USPC 715/234

(57) ABSTRACT

In one example, a method performed on a computing system includes receiving a first query for a product, receiving an input that comprises a collection of colors, determining, based at least in part on the input, one or more candidate color palettes, presenting the one or more candidate color palettes on a web site, receiving a selection that specifies one of the candidate color palettes as a selected color palette, providing, on the web site, a list of products based at least in part on the first query and the selected color palette and adjusting the list of products in real-time as a user moves a camera on a mobile device and provides new color input.

### RELATED APPLICATIONS

This application claims priority to U.S. Provisional Patent Application 61/812,714, filed 16 Apr. 2013 and U.S. Provisional Patent Application 61/813,171, filed 17 Apr. 2013 and is a continuation-in-part to U.S. patent application Ser. No. 14/029,266, filed Sep. 17, 2013, which claims priority to PCT application PCT/US2011/028848, filed Mar. 17, 2011 and titled “COLOR-BASED DESIGNS.” All the applications cited in this paragraph are incorporated herein in their entirety.

### BACKGROUND

Consumers may wish to purchase and match products based on how well the colors of the products correlate with one another. In some examples, a given color may pair more pleasingly with one color than another. Two or more colors which can be paired aesthetically can be described as forming a harmonious color scheme. In general, harmonious color schemes are combinations of colors that are pleasing to the human eye. Color theory is a method that attempts to express rules that define which colors are harmonious with each other.

### SUMMARY

In one example, a method performed on a computing system includes receiving a first query for a product, receiving an input that comprises a collection of colors, determining, based at least in part on the input, one or more candidate color palettes, presenting the one or more candidate color palettes on a web site, receiving a selection that specifies one of the candidate color palettes as a selected color palette, providing, on the web site, a list of products based at least in part on the first query and the selected color palette and adjusting the list of products in real-time as a user moves a camera on a mobile device and provides new color input. Other embodiments of this aspect includes corresponding systems, apparatus, and computer programs, configured to perform the actions of the methods, encoded on computer storage devices.

These and other embodiments may each optionally include one or more of the following features. The first query includes a selection of a product category from a list of product categories. The first query includes a text-based query that describes a product. Receiving an input includes receiving an uploaded image. Determining one or more candidate color palettes includes extracting color attributes from the input. Weights are applied to the color attributes after the color attributes are extracted from the input. Extracting the color attributes includes identifying one or more of a hue, a saturation, and a value of one or more pixels associated with the input. The color attributes are stored in a database. A similarity of the candidate color palettes to the input is evaluated. The candidate color palettes are ranked based on the evaluating. Default weights are applied to colors in the candidate color palettes and the selected color palette. A control for is provided altering weights of colors associated with the selected color palette or the candidate color palettes. The input includes a product in a shopping cart associated with a user account. The products are ranked on the list of products. Ranking the products includes evaluating the process:

$$HR ( A ) = {lim}_{range ( {v}_{j} )} {lim}_{Δ h \to {t}_{h}} {lim}_{s \to 0} {\sum }_{i = 1}^{n} {W}_{i} {P}_{i} ( 1 - \frac{\sqrt{Δ {S}_{i}^{2} + {( Δ {h}_{i} )}^{2}}}{\sqrt{{md ( {S}_{q} )}^{2} + {( {t}_{h} )}^{2}}} )$$

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of a design system.

FIG. 2 is a flow chart of a process for selecting products.

FIGS. 3-6 are screenshots of user interfaces provided by a design system.

FIGS. 7A and 7B are diagrams of color theory models.

FIG. 8 is a flow chart of a process for providing color attributes to a database.

FIG. 9A is a flow chart of a process for providing color palettes.

FIG. 9B shows controls for adjusting color-related parameters.

FIG. 10 is a flow chart of a process for ranking products.

FIGS. 11A and 11B are diagrams of models used to rank products.

FIG. 12 is a flowchart of a process for adjusting results in real-time.

FIG. 13 is a diagram of a computing system.

Like reference symbols in the various drawings indicate like elements.

### DETAILED DESCRIPTION

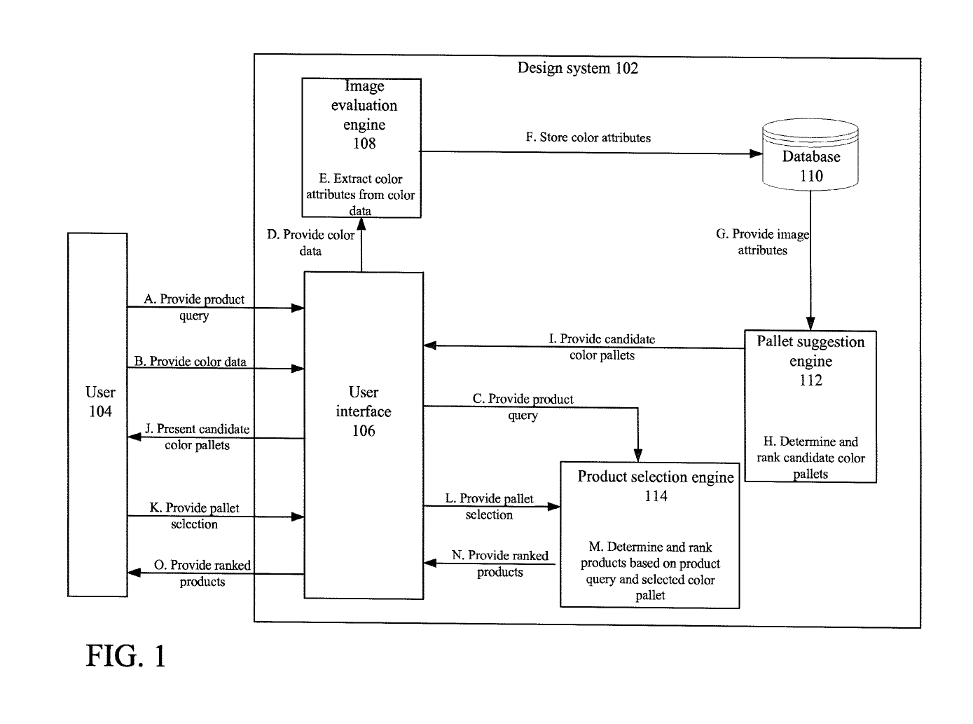

FIG. 1 shows a design system 102. In general, the design system 102 is a combination of hardware and/or computer software that enables a user 104 to interact with various aspects of design. For example, the design system 102 can provide a web site on which the user 104 can browse for products (e.g., home design products such as wallpaper, furniture, and the like, and/or other products, such as clothing, cosmetics, etc). The design system 102 can assist the user 104 in identifying appropriate products for various applications and contexts. For example, the design system 102 may assist the user 104 by suggesting a couch of a particular style and color for incorporation into a room having various properties (e.g., a living room with a particular wall color, square footage, and layout).

In some examples, such as the example shown in FIG. 1, the design system 102 can enable the user 104 to browse for products that correspond to one or more color schemes (sometimes referred to as “color palettes”), and may even assist the user 104 in selecting one or more color schemes by combining aspects of color theory, design rules, and information provided by the user 104 or other users (e.g., neural networking, which relies on the collection, collaboration, and organization of information collected from a plurality of users). In some examples, color palettes are groups of two or more colors that are harmonious according to color theory principles and rules, or that are otherwise aesthetically pleasing or desirable. In FIG. 1, the design system 102 assists the user 104 by suggesting harmonious color palettes to the user 104 based at least in part on color theory and user input, and then helps the user 104 locate products (e.g., decorative home design products, such as an area rug) based at least in part on the color palettes suggested by the home design system 102 and approved by the user 104.

FIG. 1 shows states A-O of the system 100. The states illustrate operations and flows of information that can allow the design system 102 to provide, to the user 104, one or more products (e.g., as a listing of products on a web page) according to a color palette selected by the user from a plurality of color palettes suggested by the design system 102. In practice, the states A-O may occur in the illustrated sequence, or they may occur in a sequence that is different than the illustrated sequence.

Referring to state A, the user 104 provides a product query (e.g., a query associated with a product that the user 104 is interested in) to the design system 102 via a user interface 106 associated with the design system. In some examples, the user interface 106 is a web site provided by the design system 102, and the product query can be a text search for a product that is entered into a search tool associated with the design system. The product query may also be a selection of a product from a list of product categories, and be further include updated, filtered, or refined product queries. For example, if a previous product query returned a list of products, the user 104 could refine the product query based on price, brand, size, style and other attributes and resubmit the refined product query as the product query illustrated in state A.

Construction of the product query may be based on attributes for certain styles (e.g., “Queen Anne” style) or patterns (e.g., striped, solid, and floral). The design system 102 can identify this and other information based on products that the user 104 has already showed interest in (e.g., if the product is in a shopping cart associated with the user 104). For example, if the user 104 has already added a Queen Anne style sofa to a shopping list, the design system 102 can construct the product query based at least in part on this information. In some examples, if the user 104 is selecting products from a list of product categories, the design system 102 may also provide product query suggestions based on attributes of previous product selections and on products that are typically used in the same design, such as various types of living room furniture. Examples include “Queen Anne Armchair,” “Queen Anne Side Table,” or “Curved Antique Wall Mirror.”

The design system 102 may also identify pattern information. For example, if the user 104 has added a striped sofa to a design or shopping cart and is now searching for pillows, the design system 102 may confirm which piece of furniture the user 104 plans to pair with the pillow and whether they plan to add it as a new item or replace an existing item. If the user 104 searches for a replacement pillow for a pillow already in their shopping list, the design system 102 may present the user 104 with the current pattern option of “floral” and may suggest alternative pattern options such as “solid.” If the user is searching for a new product, then the design system 102 can retrieve the existing pattern data for accessories that are already associated with the striped sofa (e.g., accessories such as pillows and throw blankets that are located on the striped sofa in an image or listing of the striped sofa) and then evaluate which patterns to suggest to the user 104. For example, if a striped sofa includes two floral pillows, the design system 102 may suggest a solid color pillow as a new product. This information can all be used to construct the product query in state A. The product query can then be provided to a product selection engine 114 associated with the design system 102 in state C. Again, the states A-O may occur in the illustrated sequence, or they may occur in a sequence that is different than the illustrated sequence.

In state B, the user 104 provides color data to the design system 102 via the user interface 106. The color data can be used by the design system 102 to suggest and/or specify one or more color palettes that will be used in the search for products that correspond to the product query. In the example of FIG. 1, the user 104 provides the color data by uploading an image (e.g., a photograph) to the design system 102 via the user interface 106. The user 104 may apply weights to regions or colors in the uploaded image that may alter the significance each weighted region or color receives in future calculations. For example, the user 104 may specify portions of the uploaded image as being more important (e.g., more heavily weighted) than other portions. In other examples, the user 104 can provide color data to the design system by identifying one or more products to the design system 102, or by browsing or searching predefined color palettes provided by the design system 102. The user 104 may also be presented with an option to select the most important color from the uploaded image, or the design system 102 may automatically select this base color in preparation for constructing the possible harmonious color palettes. This base color helps the design system 102 identify possible query palettes that may be constructed using color theory rules.

As part of state B, the design system 102 may prompt the user 104 to select one or more products from their shopping list that they wish to match, or that they wish to use as a basis for the selection of a color palette. The design system 102 may also pre-select products for the user 104 based on the product query submitted in state A. For example, if the user 104 is searching for a faucet and has already added a chrome towel rod to their shopping list, the design system 102 may preselect the chrome towel rod and save instructions for a later instance in which the user 104 may provide further input on color palettes.

In state D, the color data provided in state B (e.g., in the form of an uploaded photograph) is provided to an image evaluation engine 108. In state E, using techniques that are described in greater detail below, the image evaluation engine 108 can identify, extract, and/or store one or more color attributes of the uploaded image. For example, the image evaluation engine 108 may evaluate the uploaded image pixel by pixel (or on some other scale, such as a group of pixels), and may identify, extract, and/or store hue, saturation, and value (e.g., color brightness) information that corresponds to the uploaded image. In state F, the image evaluation engine 108 stores the color attributes in the database 110 (or otherwise makes the color attributes available for storage in the database 110).

In state G, the palette suggestion engine 112 is provided with the color attributes stored in the data base 110 (e.g., in response to the palette suggestion engine 112 calling for the color attributes). In state H, the palette suggestion engine 112 can use the retrieved color attributes to determine and rank possible color palettes. In some examples, the palette suggestion engine 112 uses the techniques described in greater detail below in order to both identify one or more candidate color palettes based on the color attributes and to rank the candidate color palettes after they have been identified according to how well the candidate color palettes correspond to the color data provided by the user 104.

In state I, the palette suggestion engine 112 provides the candidate color palettes to the user interface 106, which in turn presents the candidate color palettes to the user 104. The candidate color palettes can be presented to the user 104 on a web site, and can be ordered according to the rank determined by the palette suggestion engine 112. The candidate palettes are presented to the user 104 in state J in order to provide the user 104 with an opportunity to select or confirm one of the candidate color palettes as the selected color palette. Once the user 104 has selected a color palette from among the candidate color palettes, the selected color palette is provided to the user interface 106 in state K. The user interface 106 then provides the selected color palette to the product selection engine 114 in state L. In some examples, the user 104 may select more than one color palette from among the candidate color palettes, and more than one selected color palette can be provided to the product selection engine 114 as a result.

In state M, the product selection engine 114 determines and ranks products based at least in part on the selected color palette and the product query. The product selection engine 114 uses a number of techniques (described in further detail below) in order to both identify products that correspond to the selected color palette in some way, and to rank the identified products according to how well the products correspond to one or both of the product query and the selected color palette. For example, if the product query was a text search for an “8′×10′ area rug,” and the selected color palette included the colors red and green, the product selection engine 114 could identify a plurality of area rugs that had dimensions of 8′×10′ and that somehow corresponded to the colors in the selected color palette (e.g., a green area rug with a red border). The product selection engine could also rank the identified products based on how well the products match one or more of the product query and the selected color palette.

In state N, the product selection engine 114 provides the ranked products to the user interface 106 which, in turn, provides the ranked products to the user 104 in state O. The ranked products can be presented to the user 104 in a variety of formats. For example, the products can be arranged on a web page in a sorted list based on the rank provided by the product selection engine 114. The user 104 can browse the ranked products and may filter the ranked products by additional constraints (e.g., by price, brand, availability, and the like).

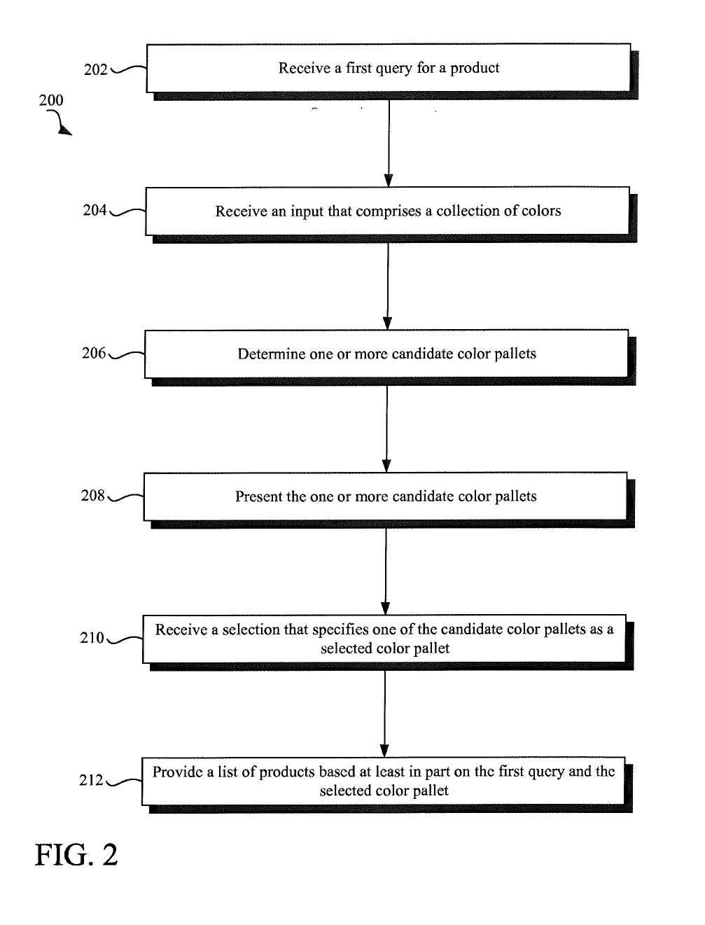

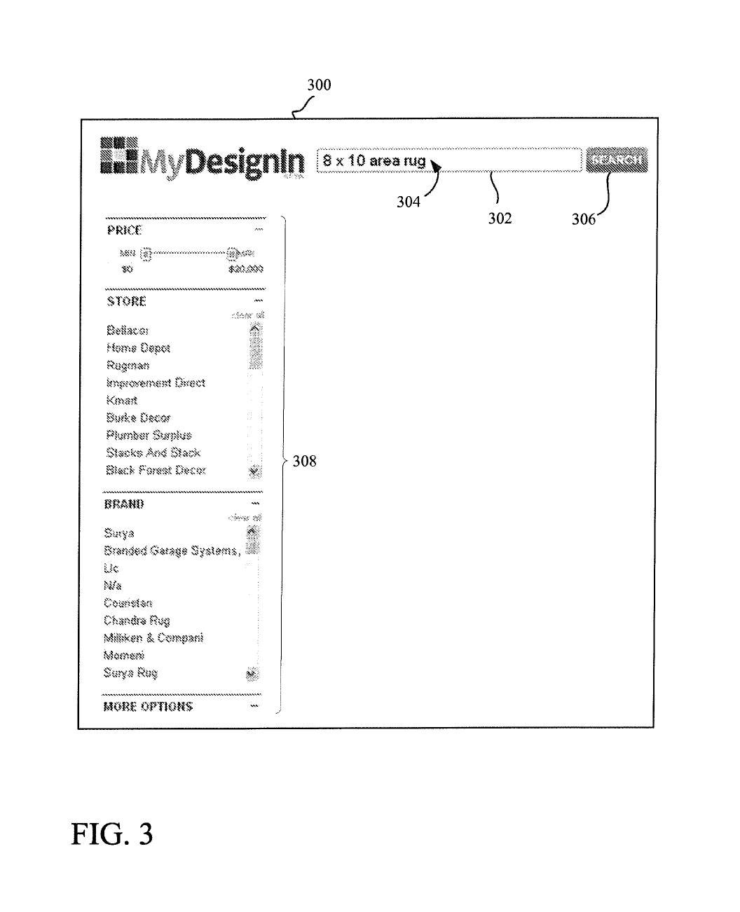

FIG. 2 illustrates a process 200 for providing a list of products. In some examples, the design system 102 receives a first query for a product (202). As described above, a product query can be a query associated with a product that the user 104 is interested in. The product query can be a text search for a product that is entered into a search tool associated with the design system, or can be a selection of a product from a list of product categories. A user interface, such as the web page 300 shown in FIG. 3, can be provided to the user 104 by the design system 102. The web page 300 can include a query box 302 for receiving a product query 304 as a string of text. In this example, the product query 304 is a text search for an “8×10 area rug.” The web page 300 may include a control 306 for submitting the product query to the design system 102 when activated by the user 104 (e.g., when the user clicks or otherwise activates the control 306 using an input device such as a mouse or keyboard). The web page 300 may also provide constraint controls 308 for filtering the products that would otherwise be returned in response to the submission of the product query 304. For example, the user 104 could use the constraint controls 308 to limit the price range of searched products, or to limit the product search to a particular brand.

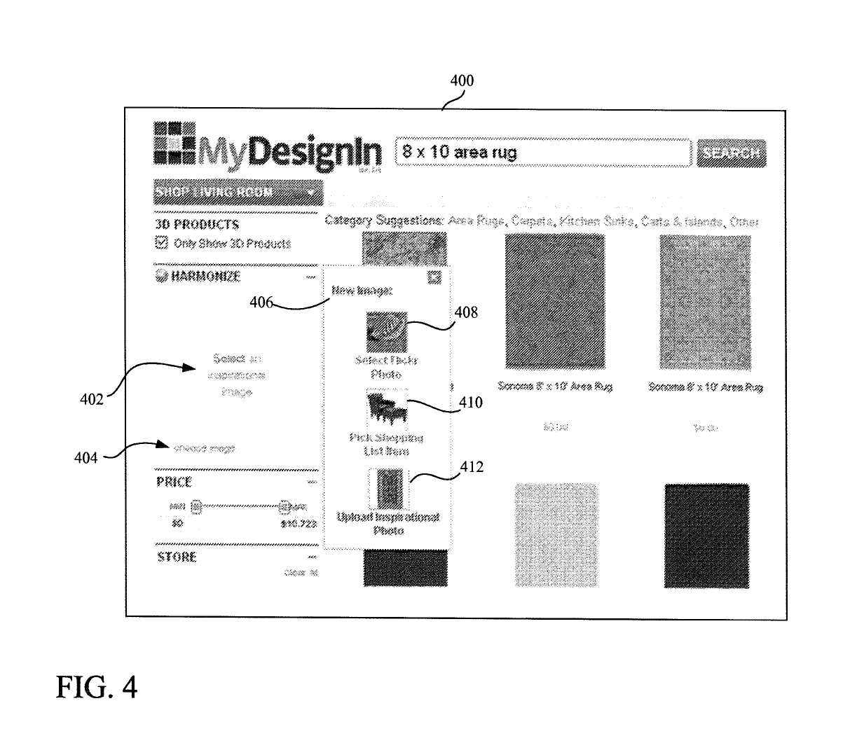

The design system receives an input that comprises a collection of colors (204). The input can be used by the design system 102 to suggest and/or specify one or more color palettes that will be used in the search for products that correspond to the product query. As shown in FIG. 4, a web site 400 can provide mechanisms for users to upload an image (e.g., a photograph) to the design system 102 to be used as a color palette inspiration. For example, the web site 400 includes an upload control 402 that allows the user 104 to choose an image that will influence the candidate palettes provided by the design system 102. The upload control 402 includes a control 404 that, when activated, causes the web site 400 to display an image selection pane 406. The user 104 can select from several upload options 408, 410, 412 in order to upload an inspirational image. For example, the upload option 408 allows the user 104 to select an image from an existing image gallery (e.g., a third party website that stores images). The user 104 can also select the upload option 410 to use a shopping list item as the inspirational image. Selection of the upload option 410 may not require an image of the shopping list product or products to be uploaded; instead, the design system 102 can draw on attributes of the shopping list product or products that are stored as metadata. Selection of the upload option 412 can allow the user 104 to upload an image from a local machine or from another storage location.

In some examples, the user 104 can provide color data to the design system by browsing or searching predefined color palettes provided by the design system 102. The user 104 may also be presented with an option to select the most important color from the uploaded image (e.g., the user 104 may provide weights to one or more colors in the image), or the design system 102 may automatically select weight the colors in preparation for constructing the possible harmonious color palettes. The weighted image helps the design system 102 identify possible query palettes that may be constructed using color theory rules. For example, if the user 104 specifies that a portion of an image that includes the color red is more important than other portions of the image which are green, the design system 102 may more heavily consider the color red when generating or identifying candidate color palettes.

The design system 102 determines one or more candidate color palettes (206). In some examples, the design system 102 uses aspects of color theory and/or one or more ranking techniques to determine candidate color palettes. Some of these techniques are described in further detail below.

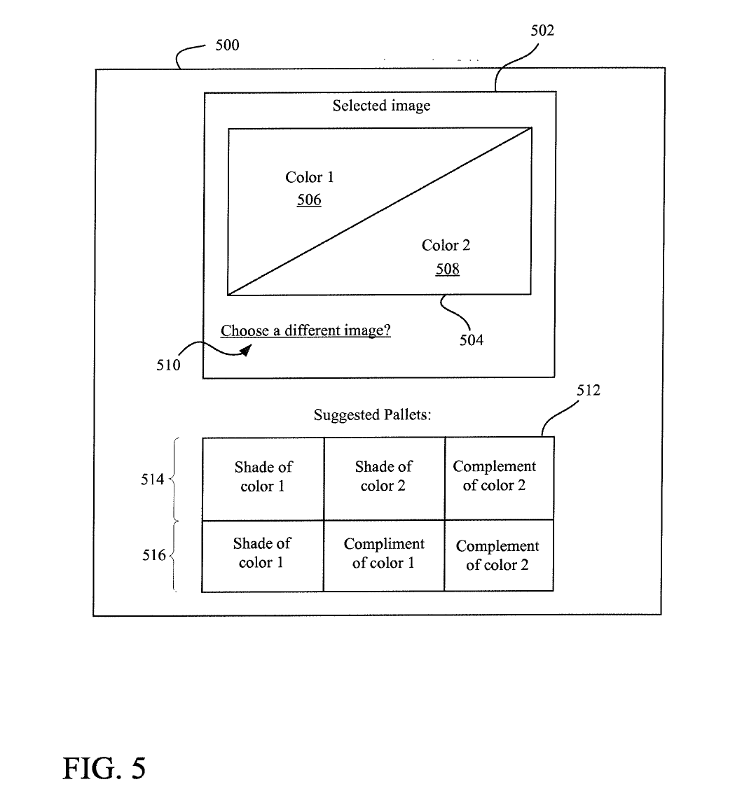

The design system 102 presents the one or more candidate color palettes (208). As shown in FIG. 5, the design system 102 can provide a web page 500 that presents the candidate color palettes 514, 516 in a color palette suggestion pane 512. In some examples, the candidate color palettes 514, 516 are related in some way to the colors in the color input. For example, the image 504 includes two colors (Color 1 and Color 2). As a result of the determination performed in (206), the candidate color palette 514 includes three colors: (1) a shade a Color 1, (2) a shade of Color 2, and (3) a complement of Color 2. The candidate color palettes 514, 516 are merely examples, as various aspects of color theory and color palette ranking can be used by the design system 102 to provide a multitude of candidate color palettes.

The web page 500 may also present the color input (e.g., the image 504) that forms the basis for the candidate color palettes 514, 516. The web page 500 may also include a control 510 for selecting a different color input that, when activated, may cause the design system 102 to determine a second set of candidate color palettes based on the newly selected color input (e.g., a second, different uploaded image). The design system 102 can present the web page 500 to the user 104 to allow the user 104 to select one or more of the candidate color palettes to be used in a product search in combination with the first query (e.g., the product query).

The design system 102 receives a selection that specifies one of the candidate color palettes as a selected color palette (210). For example, the user 104 can use an input device such as a mouse to select (e.g., by clicking) one or more of the candidate color palettes 514, 516. If the user 104 selects the candidate color palette 514, the candidate color palette 514 will be designated as a selected color palette that can be in a product search in combination with the product query (e.g., the product query).

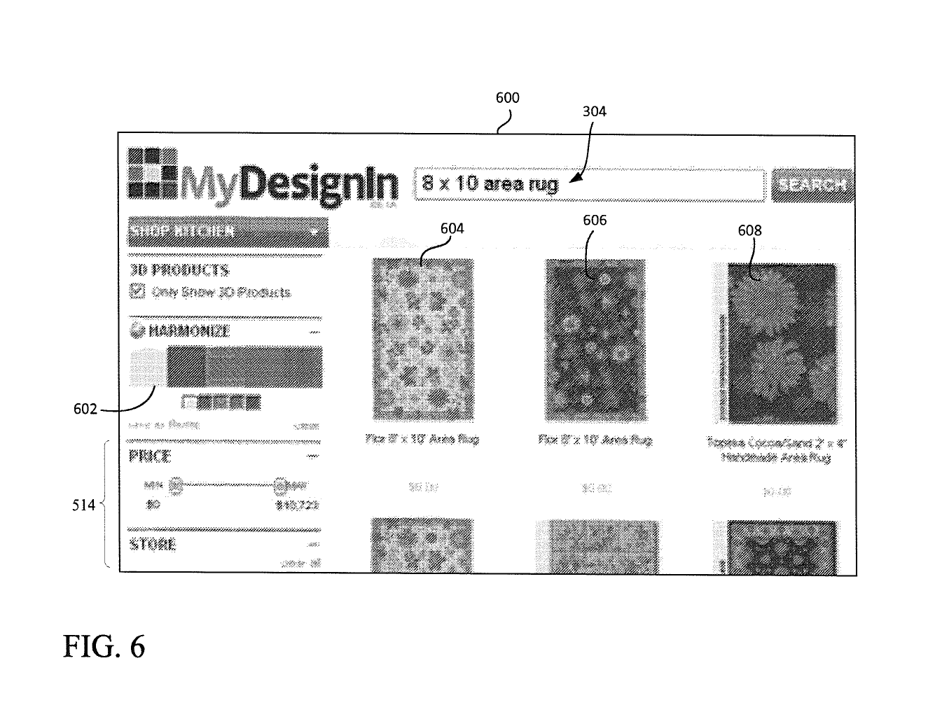

The design system provides a list of products based at least in part on the first query and the selected color palette (212). For example, as shown in FIG. 6, the design system 102 can provide a web page 600 that includes a selected color palette 602, the product query 304, and one or more matched products 604, 606, 608 that have been identified by the design system 102 based at least in part on both the selected color palette 602 and the product query 304. The design system 102 can identify the matched products 604, 606, 608 using the techniques described below. The web page 600 may also include constraint controls 514 for applying one or more additional filters to the matched products 604, 606, 608 (e.g., by adjusting a price range of the matched products 604, 606, 608).

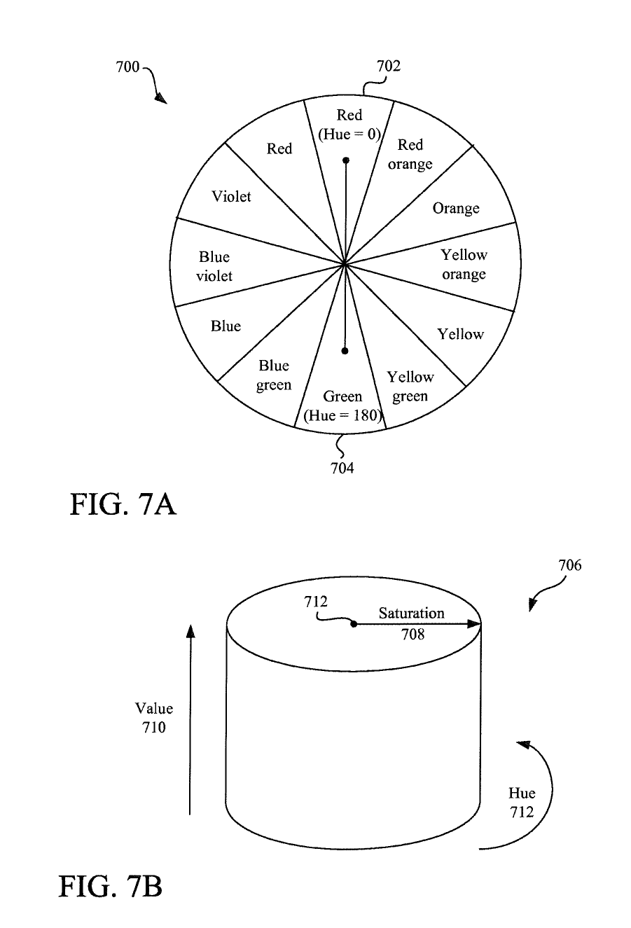

FIGS. 7A and 7B are diagrams that will be used to describe some aspects of color theory which can be used by the design system 102 to extract color attributes from images, to determine candidate color palettes, and to identify and provide products based at least in part on one or more selected color palettes. FIG. 7A shows a color wheel 700 which, in general, is an abstract illustrative organization of color hues around a circle that shows relationships between the colors. Color theory originated using red-yellow-blue (RYB) as primary colors. As it was studied how light is perceived by humans, it was discovered that the receptors in a human eye are capable of sensing three colors red, blue and green (RBG). The brain processes the three colors by mixing them together and creating the colors within the visible spectrum. The process of combining these colors to create new colors is called an additive color model and results in a broad range of hues. Further studies showed that red-yellow-green-blue (RYGB) and cyan-magenta-yellow (CMY) may in fact be appropriate for some applications. All four schemes may apply to different applications.

Color wheels can be used to illustrate various color schemes. For example, the color wheel 700 illustrates a complementary color scheme by showing the relationship between the color red 702 and the color green 704. Because these colors are directly opposite one another on the color wheel 700, the color red 702 and the color green 704 are complementary (e.g., they contrast highly with one another). Other color schemes, such as monochromatic, analogous, split complementary, triadic, and tetradic color schemes can also be illustrated on a color wheel, but will not be specifically discussed herein.

Colors can be defined using a number of parameters. For example, as shown in the color wheel 700, a color can be defined by its hue (H). In general, a hue is a color that is measured as an angle within a color wheel. For example, in the color wheel 700, the color red 702 has a hue angle of 0 degrees. Colors can also be defined in terms of their saturation, which represents how much of a given hue is in a color, ranging from no color to a pure color. Saturation can be measured from the center of a color wheel on a scale of 0 at the wheel's center to 1 at the wheel's edge. For a color with saturation (S) of 0, the color would appear gray, black, or white regardless of its hue. A color with S=1 would be a pure color. A color can be further defined by its value (V), which represents the lightness or darkness of the color. A color's value can also range from 0 to 1. A color with V=0 appears black, while a color with V=1 is the lightest version of the color for a given saturation.

FIG. 7B is a hue-saturation-value (HSV) color space model 706. As shown in FIG. 7B, the HSV color space model 706 can define a color in terms of its coordinates within the HSV color space model 706. As before, a color's hue 712 is based on its angle relative to a central point 712 within the HSV color space model 706, a color's saturation 708 is based on its distance from the center of the HSV color space model 706, and the color's value 710 is based on its height with respect to the HSV color space model 706.

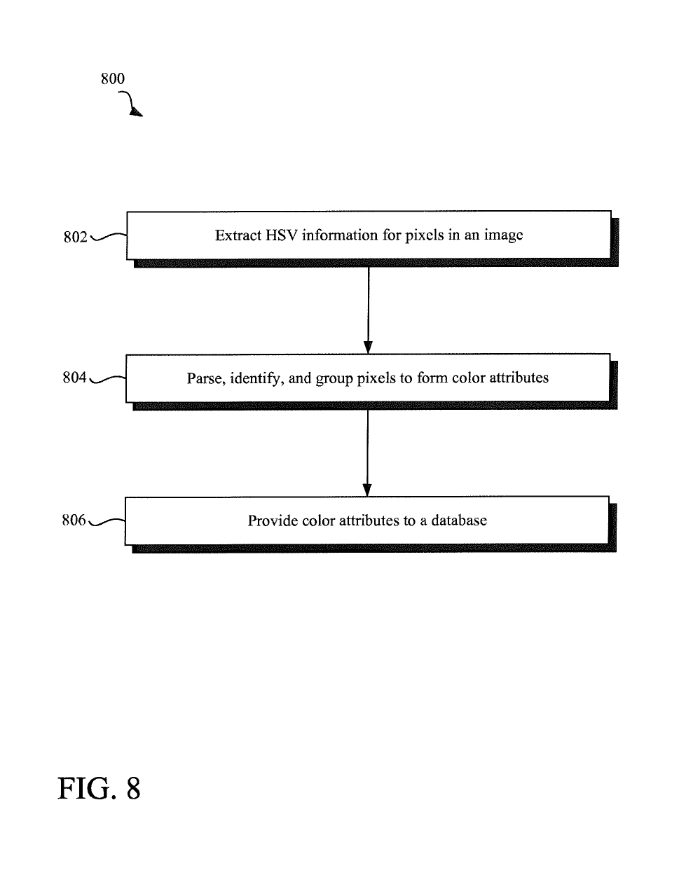

FIG. 8 shows a process 800 for extracting color attributes for an image that will be used to generate one or more candidate color palettes. The design system 102 can use elements of color theory (such as those described above) in order to extract, store, and categorize the color attributes of a given image.

The design system 102 (e.g., the image evaluation engine 108) extracts HSV information for pixels in an image (802). For example, an image (e.g., a digital photograph) provided by the user 104 is made up of many pixels, each of which represent a color. The design system 102 extracts the color information from each pixel and maps the extracted information to an appropriate color space within a color model (e.g., the HSV color space model 706) for each pixel. One purpose of the process 800 is to prepare query images for generating color palettes or to prepare products to be added to an index for image retrieval and searches.

For calculating hue angle during image processing, the design system 102 can divide a hue circle into as many angles as required until a probability threshold is reached that can provide accurate results. For example, the system may store 192 hues angles. However, as a simple example, the hue data can be stored for 12 main hues of the color wheel, as in the following table (the radian angle below is in RYB-based HSV space):

| | Hue | | | | | | | | | | | |
|---|---|---|---|---|---|---|---|---|---|---|---|---|
| | | Red- | | Yellow- | | Yellow- | | Blue- | | Blue- | | Red- |
| | Red | Orange | Orange | Orange | Yellow | Green | Green | Green | Blue | Violet | Violet | Violet |
| Radian | 2π | π/6 | π/3 | π/2 | 2π/3 | 5π/6 | π | 7π/6 | 4π/3 | 3π/2 | 5π/3 | 11π/6 |
| angle | | | | | | | | | | | | |

As an example assume there are 10 possible numerical values for saturation ranging from 0.1-1.0. Assume S=0 is ignored. This means there are 120 possible hue-saturation pairs (H|S pairs) for each image in this scenario.

The design system 102 parses, identifies, and groups pixels to form color attributes (804). In some examples, the design system 102 identifies H|S pairs for each pixel and groups them (e.g., according to the color of the pixel based on a threshold similarity) as well as identify the percentage (P) of the image those H|S pairs make up. This process may result in values being stored in formats such as: H|S|V|P, where H is the hue, S is the saturation, V is the average value, and proportion of the image that the given H|S pair makes up (e.g., what percentage of the image the HIS makes up). As an example, an image that is 100% red could be stored as 0|0.5|0.5|1.00 where the red color has hue angle of 0, a saturation of 50%, an average value of 50%, and a P of 1.00.

The design system 102 can ignore certain pixels when measuring colors for both query image(s) (e.g., images used to provide color data, as in state B (FIG. 1)) and for result images. Pixels that can be ignored may be associated with image backgrounds, scenes behind a product, and black, white, and/or gray pixels. Edge detection and object recognition technology may be used to detect the meaningful portion of an image. For example, an edge detection process may be used to separate an image of an area rug from a substantially uniform background.

White, black and gray pixels may be ignored or treated separately since they are “neutral gray colors” and may have a lesser impact on identifying harmonious colors. However, these pixels may be useful for finding image similarity (correlation). As an example, if an image includes equal distributions of red and white stripes, the design system 102 might only include the red stripes in the count of pixels for the image. The white stripes can be ignored since the S=0.01 for the white stripe pixels and, as a result, they are marked as neutral gray. Edge detection may further assist in identifying pixels near the edges of the stripes that are a mix of red and white and that should also be ignored.

An advantage of such an approach is that only the red pixels are indexed as contributing to 100% of the image's P value and, as a result, the design system may assign 100% as the weight (W) for a given query H|S pair. This results in red being assigned P=1 for the image as a search result and W=1 for the image as a query. Without this process, red as a single H|S pair for a result image would be assigned P=0.50 for red and P=0.50 for white (and as a query W=0.50 for red and W=0.50 for white).

If a pixel has no color saturation (S=0) or a color saturation within a given tolerance, then the color of the given pixel is gray, black, or white. Tolerances for S may be set differently for different values of V. For example for better evaluating white tints, the design system 102 may allow for smaller saturations. If a pixel has a value of V=0 (or is within a given tolerance for V), it may considered black by the design system 102. As a result, the design system 102 can ignore this pixel, which effectively reduces the number of pixels that are used in percentage of image calculations. Tolerances for determining neutral gray colors can be retrieved from a database during this process.

Neutral gray color definitions can also be stored, and the design system 102 can then use a query to decide whether to include all or some of the stored neutral color values for H|S|V|P in ranking calculations which can be stored separately as NGH|S|V|P where NGH is neutral gray hue angle. For example, if the user 104 is looking for a product that is similar to a query image, an image correlation (similarity) search can be executed. In this case, W (the percentage of each H|S pair in the query image) can be set equal the example percentage value of for each given H|S pair. These techniques can be used for neutral brown colors, as discussed below.

Neutral brown colors may range from red to yellow for hue angles. They are also defined as having certain saturation and value ranges depending on the hue angle. Tolerances for hues angles can be retrieved from a database during this process. In design, it possible to match neutral brown hues with other neutral brown hues. However, it may also be useful to ignore neutral brown colors (e.g., the color tan) if a result image only returns matching colors. By excluding the neutral brown colors, the search result can have an improved recall (number of documents returned in a search result) and precision (accuracy). For example, by including a beige color in the ranking calculations, a search result consisting of a beige pillow with small pink dots may have not satisfy color matching tolerances for a given query. This would have resulted in the product being excluded from the search result. In this case, if the product did satisfy matching tolerances, it still would have a very small P for pink resulting in poor precision. By excluding the beige color, both precision and recall are increased for a given pink query since the P for the pink color in the pillow may be equal to 100%.

Neutral brown and neutral gray H|S pairs can be separately stored in order to increase flexibility by allowing the query to decide whether to include neutral brown colors in the ranking results. If neutral colors are excluded during a ranking process, the design system 102 might adjust the value for P to be relative only to the sum of a color's P value for a given image document. Neutral brown H|S pairs can be stored as: NBH|S|V|P.

For each set of neutral gray, neutral brown and color H|S pairs, the design system 102 can send the information to separate histograms. A visual image of a histogram of the image might show H|S pairs on an x-axis and a weight or percentage (W or P) on the y-axis.

In some examples, if the design system 102 is configured to evaluate and store 192 hues, 10 saturations, and 10 values for each H|S|V grouping (e.g., for each color), storing H|S|V groupings may be too data intensive for many applications. Instead, the design system 102 may use weighted averages for value and saturation to reduce the size of the index containing the H|S|V information. Instead of measuring and storing S for each H, the system may use a weighted average saturation for each hue angle. For example, storing 10 possible saturations for 192 hue angles results in 1,920 possible sets of H|S|V|P for indexing result images (e.g., images that are identified by the design system 102) and H|S|V|W for storing query data (e.g., images that are associated with a user query). This is just for colors not including neutral colors. Probability and number of pixels in images can reduce this number significantly. However, in some examples, a weighted average saturation can be used for each H|S pair. This reduces the number of pairs to 192 H|S pairs for colors. Neutral brown can be reduced to about 64 H|S pairs since it ranges from red to yellow. Neutral gray may only require the storage of V data, along with either P or W data.

For example, average saturation sₐ for each of 192 hues angles for an image result document can be calculated as:

$${s}_{a} = {\sum }_{i = 1}^{n} \frac{{P}_{i} {S}_{i}}{n}$$

The average saturation sₐ for each of 192 hues angles for a query document can be calculated as:

$${s}_{a} = {\sum }_{i = 1}^{n} \frac{{W}_{i} {S}_{i}}{n}$$

Other techniques for reducing the number of entries to the index but increasing the precision (accuracy) of search results and queries can also be used. For example, the design system 102 may divide saturation in three sections, and may then perform an average calculation for each section.

The design system 102 provides color attributes to a database (806). For example, once extracted, parsed, and/or grouped, the color attributes can be mapped to a histogram where the H|S pairs are mapped to the x-axis and either P or W is mapped to the y-axis. The design system 102 may calculate P and/or W for each H|S pair, as well as an average value for each H|S pair.

For example, suppose an image has the following color attributes:

### Product ID=220

| | Low | Medium | High |
|---|---|---|---|
| | Saturation | Saturation | Saturation |
| Red - 0 | S = 0.1, V = | P = 0 | S = 0.9, V = |
| Degrees = 0 Rad | 0.7, P = 0.1 | | 0.7, P = 0.6 |
| Green = 180 | S = 0.1, V = | P = 0 | P = 0 |
| Degrees = 3.14 Rad | 0.4, P = 0.1 | | |
| Neutral Brown = | | S = 0.35, V = | |
| 34° = 0.59 Rad | | 0.82, P = 0.10 | |

When P=0, entries associated with those P values can be eliminated from the index. Thus, an entry in the index/database could resemble the following:

| Product | | |
|---|---|---|
| ID | Color Data | Attributes |
| 220 | 0\|0.1\|0.7\|0.1; 0\|0.9\|0.7\|0.6; 3.14\|0.1\|0.4\|0.1; | Striped, Queen |
| | NB0.59\|0.35\|0.82\|0.10 | Anne . . . |

The index above represents a result image. For a query image a similar index could be provided by replacing all P values with W values (to produce index entries in the H|S|V|W format).

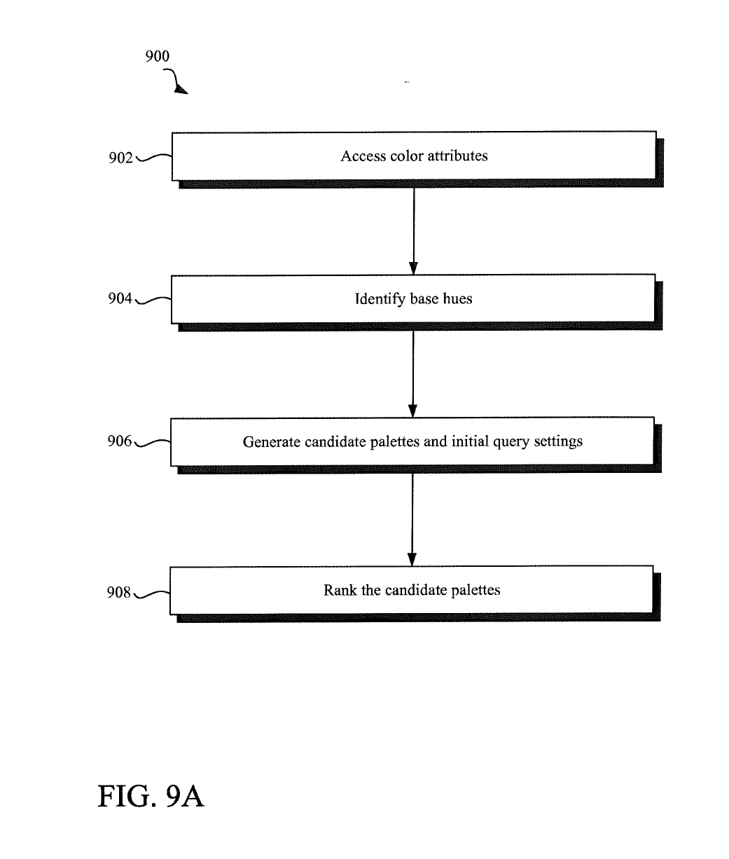

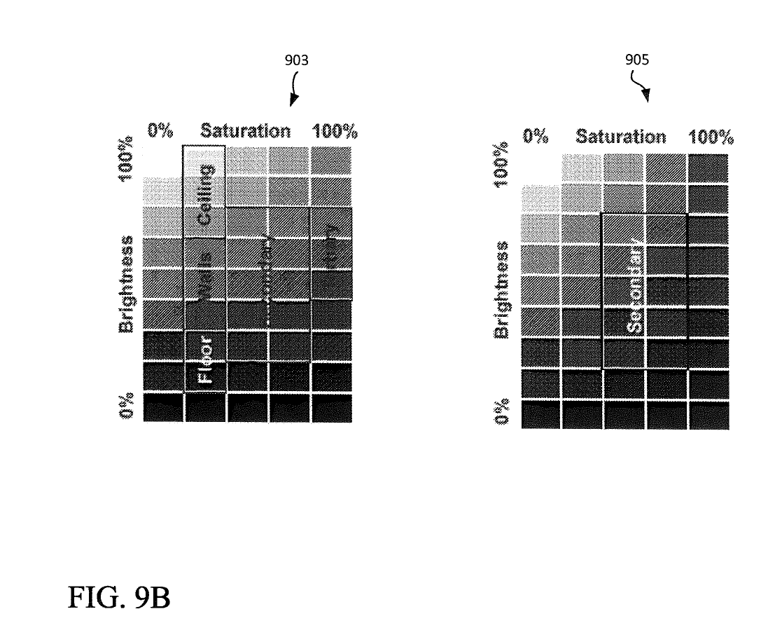

FIG. 9 shows a process 900 for identifying candidate color palettes. The design system 102 accesses color attributes (902). For example, the palette suggestion engine 112 (FIG. 1) of the design system 102 can access color attributes stored in the database 110 to extract H|S|V|P and/or H|S|V|W information. The color attributes can be stored in the database 110 using the techniques and formats discussed above. For example, an image may have color attributes that indicate that the image is 40% green, 10% red, 20% Black, 20% White and 10% Blue-Violet. The retrieved color attributes could resemble the following:

Red color: 0|0.75|0.65|0.10
Green color: π|0.75|0.65|0.40
Blue-Violet color: π/2 |0.75|0.65|0.10
Black color: NG0|0|0|0.20
Pure white color: NG0|0|0.20

The color attributes above are in the H|S|V|P (Hue|Saturation|Value|Percentage) format. The notations NB and NG are used to represent colors that are neutral brown or neutral gray (Black, White, Gray).

After the palette suggestion engine 112 has accessed the color attributes, the design system 102 identifies base hues (904). For example, a hypothetical query can be generated using increments of hue angles that have a hue tolerance tₕ. For example assume that

$${t}_{h} = \pm \frac{π}{12}$$

and the initial hypothetical query is hue angle=0. The hue tolerance and all numerical values (e.g., color attributes that meet the hue tolerance) are plugged into the formula:

$$HR ( A ) = {lim }_{Δ h \to {t}_{h}} {\sum }_{i = 1}^{n} {W}_{i} {P}_{i} ( 1 - \frac{Δ {h}_{i}}{{t}_{h}} )$$

Which evaluates to the following value:

$$HR ( A ) = {lim }_{Δ h \to \pm \frac{π}{12}} {\sum }_{i = 1}^{n = 1} 1 * 0.1 ( 1 - \frac{0}{\frac{π}{12}} ) = 0.1$$

Now assume the hue increments for each additional the hypothetical query is

$$+ \frac{π}{24} .$$

Accorgingly, the next query uses

$$\frac{π}{24}$$

for hue angle and evaluates to the following value:

$$HR ( A ) = {lim }_{Δ h \to \pm \frac{π}{12}} {\sum }_{i = 1}^{n = 1} 1 * 0.1 ( 1 - \frac{\frac{π}{24}}{\frac{π}{12}} ) = 1 * 0.1 ( 1 - 0.5 ) = 0.05$$

Hue rank is a simplified version of harmonize rank where only the hue angles are used for ranking products or palettes. Base hue is the initial hue identified for generating a color palette. For example, a base hue of red results in a complementary hue of green when using the complementary color theory method. If we assume that a tolerance for hue rank is set as 0.06, then red with a hue angle of 0 qualifies for a base hue. However, red with an angle of

$$\frac{π}{24}$$

does not meet the 0.06 tolerance, so the design system 102 may exclude it as a base hue. Next, the design system 102 may evaluate the weighted average for the saturation for each qualifying base hue using the following formula:

$$S ( Base Hue ) = {\sum }_{i = 1}^{n} \frac{{p}_{i} {S}_{i}}{n}$$

Which evaluates to the following value:

$$S ( Red at 0 Degrees ) = {\sum }_{i = 1}^{n = 1} \frac{100 \% * 0.75}{1} = 0.75$$

Since there is only one red H|S pair in the image which has one saturation value, the saturation's weighted average is simply equal to 0.75 or the original saturation. This process can be repeated for all hue increments for all hypothetical queries and all of the color attributes retrieved from the database 110.

The design system 102 generates candidate palettes and initial query settings (906). With a set of base hues generated, the design system 102 can generate candidate palettes from the base hues using color theory schemes such as monochromatic, analogous, complementary, and split complementary schemes. For example, using the base hue of green 180 degrees, the design system 102 can generate palettes for each color theory rule. For example, using the complementary color scheme with the base hue of green, and when H1 is base hue and H2 is the second complementary hue generated from the base hue, the design system 102 calculates H2 as follows:

H2=H1±π

H2=π±π=0=Red

As a result of the evaluation shown above, with green as the base hue, the two colors using the complementary palette are green and red. In some examples, as part of the initial query settings, rules for editing or adding additional H|S pairs may require that all H|S pairs for the query must have hues that match the base hue and/or the complementary hue. However, saturations and values may differ. The representative color palette may consist of two colors: red and green. These initial query settings can allow the system present a drop down menu to the user that includes actual color selections for their query allowing the user to select multiple saturations and value combinations for the given hue. In addition a drop down=for suggested Neutral Browns and Neutral Grays may also be presented.

As part of the initial query settings, the design system 102 may associate different regions with one or more colors in the palette. For example if the user 104 is creating a more traditional design, the design system 102 may present the user 104 with regions for saturation and value for each of the major parts of design. In interior design, for example, the primary areas are typically the wall, the floor, and ceiling coverings. These are traditionally the least saturated colors, with floors having the darkest value, walls having a lighter value, and the having ceiling the lightest value. Area rugs, furnishings and window treatments are typically secondary areas which typically have a relatively moderate saturation. Vases, lamps and wall art are tertiary items that are typically the most saturated. The design system 102 can vary the value of V to increase the estimated visual interest of a design.

In this case, the system may identify the current query of “8×10 area rug” as an item that may be well-suited for the “secondary area”. However it may also identify it as an accent piece. When using a complementary color scheme, a limited amount of the color that is complementary to the base hue can be used to avoid color tension. In this case, a limited amount of red (which is complementary to the base hue of green) should be used. In the case of accent pieces, the complementary color of red may be presented to the user as a color they should pick for the current query. If the system decides it is not an accent piece then the base color or neutral colors may be selected as the default setting for the user.

In addition, if the expected location of the “8×10 area rug” is near a light colored wall and on a lighter colored hardwood floor, the design system 102 may reduce the value range of the V component to a much darker color within the secondary area, such as by selecting red color with a 15-25% value as:

$${lim}_{range ( {v}_{j} )} = 0.15 to 0.25 .$$

The design system 102 ranks the candidate palettes (908). For example, after the design system 102 has determined the candidate palettes, the design system 102 (e.g., the palette suggestion engine 112) can rank the candidate palettes against the color attributes retrieved from the database. In some examples, the design system 102 ranks the candidate palettes against color attributes that represent the image uploaded by the user 104 as a design inspiration.

To rank the candidate palettes, the design system 102 may first identify the relevant colors. For example the design system 102 may identify the following as relevant colors that satisfy the hue tolerance:

Red color is 0|0.75|0.65|0.10
Green color is π|0.75|0.65|0.40

The design system 102 may then adjust the value of P so the sum of all P values is equal to 1.00, shown as follows:

$$Adjusted P ( H \vert S Pair ) = \frac{P}{\sum p}$$

$$Adjusted P ( Red ) = \frac{0.1}{( 0.1 + 0.4 )} = 0.2$$

$$Adjusted P ( Green ) = 0.8$$

According to the above calculations, the adjusted values for computation would be the following:

Red color: 0|0.75|0.65|0.20
Green color: π|0.75|0.65|0.80

With the adjusted values calculated, the design system 102 then chooses a process for ranking the color palettes. For example, the design system 102 may elect to implement the following ranking process (which allows for changes in saturations due to the use of the complementary palette in this example):

$$HR ( A ) = {lim}_{Δ h -> {t}_{h}} {\sum }_{i = 1}^{n} {W}_{i} {P}_{i} ( 1 - \frac{Δ {h}_{i}}{{t}_{h}} ) -> \\ HR ( A ) = {lim}_{Δ h -> {t}_{h}} {\sum }_{i = 1}^{n} {W}_{i} {P}_{i} ( 1 - \frac{\vert {h}_{q} - {h}_{r} \vert}{{t}_{h}} )$$

The design system 102 then substitutes query parameters (e.g., the parameters associated with candidate color palettes) into the ranking process. W=1 is set by default for this ranking process (P values for the query palette are ignored). The values are substituted as follows:

$${t}_{h} = \pm \frac{π}{12}$$

$${h}_{q} = 0 for red$$

$${h}_{q} = π for green$$

$$HR ( A ) = {lim}_{Δ h -> \pm \frac{π}{12}} 1 * {P}_{i} ( 1 - \frac{\vert 0 - {h}_{r} \vert}{\frac{π}{12}} ) + 1 * {P}_{i} ( 1 - \frac{\vert π - {h}_{r} \vert}{\frac{π}{12}} )$$

The design system 102 then substitutes the result parameters (e.g., the color attributes associated with the image uploaded as a design inspiration) into the ranking process, as follows (the adjusted P numerical value can be used as above):

$$Red color is 0 \vert 0.75 \vert 0.65 \vert 0.20$$

$$Green color is π \vert 0.75 \vert 0.65 \vert 0.80$$

$${h}_{r} = 0 for red$$

$${h}_{q} = π for green$$

$$HR ( A ) = {lim}_{Δ h -> \pm \frac{π}{12}} 1 * 0.2 ( 1 - \frac{\vert 0 - 0 \vert}{\frac{π}{12}} ) + 1 * 0.8 ( 1 - \frac{\vert π - π \vert}{\frac{π}{12}} )$$

$$HR ( A ) = 0.2 + 0.8$$

$$HR ( A ) = 1.00$$

Since the original image only included hue angle of 0 and π, the result is a perfect match of 1.00. Accordingly, the design system 102 would rank the candidate palette associated with the score of 1.00 relatively high.

As an alternative example, one or more items in a user's shopping list (or the shopping list as a whole) can be used as the color inspiration (e.g., in place of an image uploaded by the user 104). If the initial query image consisted of the user's shopping list, the design system 104 would evaluate the shopping list and existing color palette; however, instead of using pixels of a single image to calculate P, the design system 102 may use a set of images from the shopping list. All H|S|V|P stored in the database for this shopping list can be based on weight adjusted versions of P for each H|S pair extracted from the shopping list items. For example assume the shopping list includes two products:

### Product 1:

Red: 0|0.5|0.5|0.50

Green: π|0.5|0.5|0.50

### Product 2

Red: 0|0.5|0.5|0.10

Green: π|0.5|0.5|0.90

Since the H|S pair for both products are the same, they are combined into a single database entry. By combining H|S pairs from multiple images from the shopping list, the shopping list (adjusted by visible surface area for each product) behaves like a single uploaded image. For example, assume Product 1 has a visible surface area of 10% of the design, and product 2 consists of 90% of the design. The following process can be evaluated:

$$Surface Area Adjusted P = {\sum }_{i = 1}^{n} {A}_{i} {P}_{i}$$

For example red can be calculated as:

Surface Area Adjusted P (Red)=Σ(0.1)(0.50)+(0.9)(0.10)=0.14

Surface Area Adjusted P (Green)=Σ(0.1)(0.50)+(0.9)(0.90)=0.86

So now this information can be stored as the following:

### Red—0|0.5|0.5|0.14

### Green—π|0.5|0.5|0.86

Aᵢ is the percentage visible surface area of a product relative to the overall surface visible area of the design. One definition of visible is the viewable area of a product within a design relative to all other products that can be seen from a given angle. The average value for the grouped H|S pairs can use the same surface area weighted method for each H|S pair.

These consistent adjustments offer a method for presenting the user 104 with the optimal palettes for creating the perfect design. As new products are added, new potential base hues are identified, new palettes are generated and ranked, and the user 104 is presented with new options for searching and revaluation of items in the design.

As new palettes are selected, items in the design can be ranked based on how well they coordinate with the palette, and the design system 102 can make suggestions for which items they may wish to re-evaluate. For example, the design system 102 may present the user 104 with a rank for how well each product matches the user's current palette. For example, if the hue angle for wall paint in a user's shopping list was previously 5 degrees and the user 104 chose a new paint color that had a hue angle of 0 degrees, the design system 102 could reevaluate the base color, generate new color palettes, and rank them in preparation for presentation to the user 104. If the user 104 is searching for a new paint color, the design system 102 may exclude the existing paint color in all calculations for color palette generation and ranking. Surface Area Adjustments for P may also be used in ranking palettes for presentation to the user.

After the design system 102 has generated and ranked the candidate color palettes, the design system 102 can present the candidate color palettes to the user 104. After the user 104 has decided to use a candidate color palette (and has adjusted any additional options, discussed below), the user 104 may select one or more of the candidate color palettes for use in a search for products. The design system 102 can present the user 104 with options for modifying default settings for each color in the color palettes (including the core palettes generated from the color theory rules and the neutral palettes that coordinate with the color scheme). For example, for the complementary color theory scheme, the design system 102 may allow the user 104 to select different saturations and values for each of the hues in the candidate color palettes (e.g., using the controls 903, 905 shown in FIG. 9B). The design system 102 may also allow the user 104 to edit default search settings for the current query and for future queries. For example, the user 104 may notify the design system 102 that they are doing a more contemporary design and the design system 102 may suggest different settings for primary, secondary and tertiary areas.

In addition, the user 104 can build palettes dynamically for all colors that they wish to use. They can assign each color to primary, secondary or tertiary areas. A visual indication of each of these palettes might show the primary colors as large swatches with secondary smaller and tertiary the smallest. The user 104 may also adjust initial weights for each color within each candidate color palette.

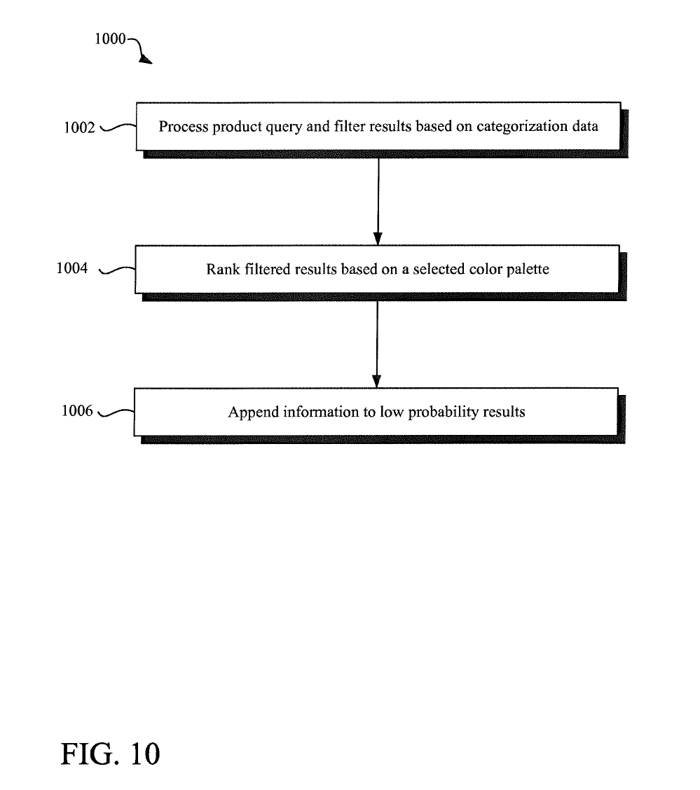

FIG. 10 shows a process 1000 for identifying and ranking products based at least in part on a product query and a selected color palette. The design system 102 processes a product query and filters results based on categorization data (1002). For example, the design system 102 parses the product query for an “8′×10′ area rug.” An ontology module can be used in the process to match product query terms with categorization data in the text query. For example, the design system 102 first identifies “area rugs” as a match via the ontology keyword database to the category called “Area Rug.” With a known category, the design system 102 can now evaluate possible attributes for the category “Area Rug” and can identify matches for refinement options (e.g., a value called “Solid” for pattern). The matched refinement options can be used as filters for the category search “Area Rugs.” “8′×10′” remains part of the text query.

The design system 102 ranks filtered results based on a selected color palette (1004). For example, assume the user 104 has selected a color palette to be used in the product search that includes the following two colors:

Green color 1: π hue, 0.75 saturation
Green color 2: 25π/24 hue, 0.5 saturation

Accordingly, the query associated with the selected color palette would have H|S pairs that resemble the following:

Green color 1: π/0.75
Green color 2: 25π/24|0.5

Also assume that the result image associated with one of the products returned from the filtered product query have color attributes that resemble the following:

### Result Color 1—π|0.75|0.75|0.6

### Result Color 2—25π/24|0.6|0.75|0.4

The design system 102 uses the following process to rank the filtered product results based on how well they correspond to the selected color palette:

$$HR ( A ) = {lim}_{range ( {v}_{j} )} {lim}_{Δ h -> {t}_{h}} {lim}_{s -> 0} {\sum }_{i = 1}^{n} {W}_{i} {P}_{i} ( 1 - \frac{\sqrt{Δ {s}_{i}^{2} + {( Δ {h}_{i} )}^{2}}}{\sqrt{{md ( {s}_{q} )}^{2} + {( {t}_{h} )}^{2}}} )$$

Limit Wₙ as follows:
If Pₙ≦Wₙ, then Wₙ=1
If Pₙ>Wₙ, then WₙPₙ−Wₙ

Also stated as:

$$HR ( A ) = {lim}_{range ( {v}_{j} )} {lim}_{Δ h -> {t}_{h}} {lim}_{s -> 0} {\sum }_{i = 1}^{n} {W}_{i} {P}_{i} ( 1 - \frac{\sqrt{{( {s}_{q} - {s}_{r} )}^{2} + {( {h}_{q} - {h}_{r} )}^{2}}}{\sqrt{{md ( {s}_{q} )}^{2} + {( {t}_{h} )}^{2}}} )$$

Limit Wₙ as follows:
If Pₙ≦Wₙ, then Wₙ=1
if Pₙ>Wₙ, then WₙPₙ=Wₙ

The variables for these processes are defined as follows. HR represents the Harmonize Rank of a given product image in a search result (e.g., how well the product image matches a query palette or query image). Search results can be ranked between 0.00 and 1.00, with larger numbers indicating higher rankings. The process uses: \sqrt{Δsᵢ²+(Δhᵢ)²} to measure the distance between each n instance of H|S pairs for each query color (QC) within the query palette or query image, and each n instance of the H|S pairs within the result color (RC). The distance between the QC and RC is used for matching H|S pairs in the product result image by finding the shortest distance between the QC and all possible RC within a given tolerance. This ensures each H|S pair in the Result Color is assigned to one QC (Query Color) and eliminates the possibility for duplicating measurements and ensuring that the highest possible HR=1. This distance is set relative to \sqrt{md(s_{q})²+(tₕ)²}, which is the largest possible distance between HIS pairs for each query colors (QC) and result colors (RC). When the distance between all n instances of QC and all RC are =0:

$$1 - \frac{\sqrt{Δ {s}_{i}^{2} + {( Δ {h}_{i} )}^{2}}}{\sqrt{{md ( {s}_{q} )}^{2} + {( {t}_{h} )}^{2}}} = 1.00$$

When \sqrt{Δsᵢ²+(Δhᵢ)²} is equal to \sqrt{md(s_{q})²+(tₕ)²}, then:

$$1 - \frac{\sqrt{Δ {s}_{i}^{2} + {( Δ {h}_{i} )}^{2}}}{\sqrt{{md ( {s}_{q} )}^{2} + {( {t}_{h} )}^{2}}} = 0.00$$

A value of 0.00 may indicate that the product result does not match the query.

The variable A in HR(A) represents the product image in a search result. The product result image is stored in an index. It groups pixels in the image together and stores them as H|S pairs. Numerical values for each H|S pair are stored as follows: P|H|S|V (Percentage|Hue Angle|Saturation|Value) that were extracted out of the image. Colors are typically measured using HSV space. However hue angle may be converted using various color models including RYB, RGB and other models. For example the system may use a RYB-based HSV space for storing color information

The variable n represents the number of H|S pairs identified in the product result image. A set of pixels in a search result image are assigned to a group using each possible saturation/value combination. Combinations that are within the query hue tolerance are considered, and there are no redundant H|S pairs for the result image, ensuring ranks between 0 to 1. H|S pairs are assigned to a single Query Hue based on the shortest distance between the Query HIS and the Result HIS. Each HIS pair is assigned a value from 1 to n and a P. In addition the corresponding Query Hue is assigned the same n value.

The variable h_{q} represents the hue of each query H|S pair within a palette. The variable s_{q} represents the saturation of each query H|S pair within a palette. The variable hᵣ represents the hue of each matching H|S pair. The variable sᵣ represents the saturation of each matching H|S pair. The variable Δsₙ represents the distance between the query saturation and the result saturation within the given hue tolerance t. It can be expressed as |s_{q}−sᵣ| for each instance of n. The variable Δhᵣ, represents distance between the query hue and the result hue within the given hue tolerance t. It can be expressed as |s_{q}−sᵣ| for each instance of n. The variable Wₙ represents the weight assigned to a given query H|S pair. The W variable and the limits for Wₙ are optional and will typically be used for image correlation purposes instead of image harmony ranking. Typically, this can be a number between 0.00 and 1.00. When W=1, weight has no impact on the rank for a given H|S pair. W may be applied to determine the image correlation between query image(s) and search result images such as identifying the similarity of room photographs, products and clothing outfits. It is also used in some user interfaces where the system or user interface allows user to select colors and assign importance for a given query. When the user is doing a palette search (described below), W may be set to 1 for all colors in the palette by default but may also be adjusted, as described above. For an image correlation search (also described below) W is set to the percentage of the query image(s).

The variable Pₙ represents the percentage of a search result image with the same H|S pair as the H|S pair of the color in a query palette. It is expressed as a percentage of the overall image. If the result color and the query color are the same (distance between QC and RC=0), the result=(Pₙ) (1)=Pₙ. In that case, the H|S pair contributes the entire amount of Pₙ. Neutral colors are excluded in the percentage calculations. Neutral gray colors (white, gray, and black with values of 0 or values within a given tolerance) may be either stored separately in the index or excluded in the calculation of P during the image color extraction/indexing process. For example, if 50% of an image is neutral gray and 50% of image matches the exact hue/saturation of the query hue, then the P=100%. The variable tₕ represents the hue angle tolerance. For example, if there are 12 hues in the color wheel, the tolerance is set to

$$\frac{π}{12} ,$$

and the query hue angle is 0, then the possible hue in a search result calculation are hue angles that are smaller than

$$\pm \frac{π}{12} .$$

Hue tolerance angles can be set for each query color independently or globally for all colors within an entire query palette. For example, cyan may have a smaller tolerance than green. The design system 102 can store a value for t for each instance of H|S pairs in the query.

The variable md(s_{q}) represents the maximum distance from s_{q} to the possible result H|S pair. Without querying all possible search results, md(s_{q}) is measured by finding the longest distance from s_{q} to either 0 saturation or 1 saturation. Thus, md(s_{q}) is measured by finding the longer distance of 1−s_{q} or s_{q}−0. The design system 102 can measure and store a value for md(s_{q}) for each instance of H|S pairs in the query. The variable range (vⱼ) represents the range of values of V (darkness/lightness of product in image) and is used to filter results.

Using the values from the example above, the values for the variables could be as follows:

$${h}_{q} ( green color 1 ) = π$$

$${s}_{q} ( green color 1 ) = 0.75$$

$${h}_{r} ( result color 1 ) = π$$

$${h}_{r} ( result color 2 ) = 25 π / 24$$

$${s}_{r} ( result color 1 ) = 0.75$$

$${s}_{r} ( result color 2 ) = 0.6$$

$$P ( result color 1 ) = 0.6$$

$$P ( result color 2 ) = 0.4$$

$${t}_{h} = \pm \frac{π}{12}$$

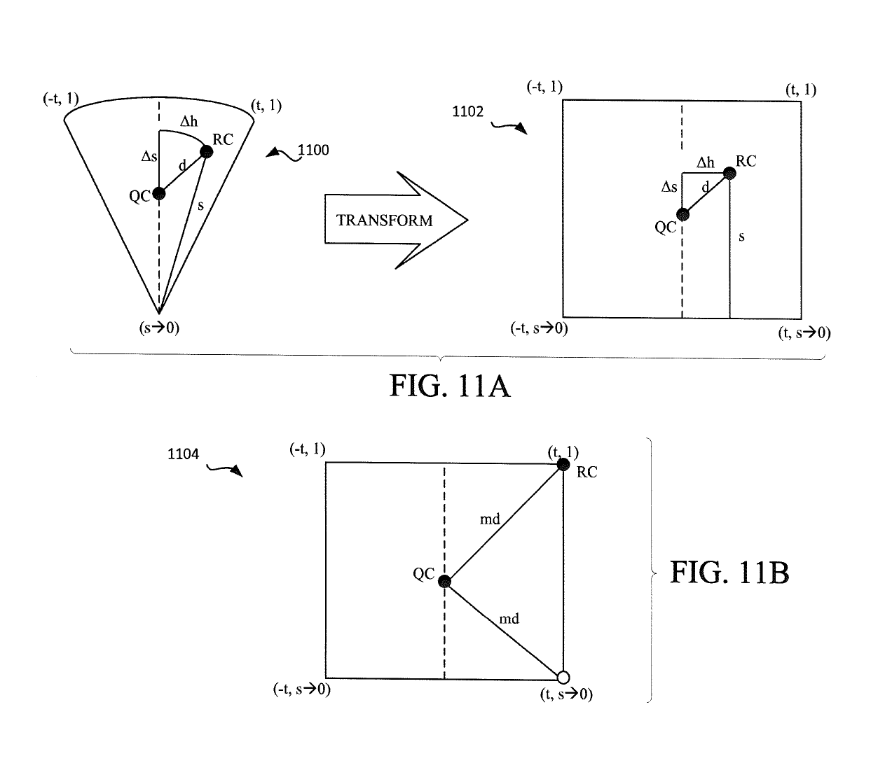

FIGS. 11A and 11B illustrate a manner in which the design system 102 may calculate a maximum distance between a query color (QC) and a result color (RC). For a given QC, the QC can be represented as a location within the HSV color space model 706 shown in FIG. 7B. Accordingly, colors represented within a HSV color space model can be represented in a portion of the HSV color space model in a pie-shaped slice 1100. In order to calculate the distance (d) between the QC and the RC, the pie-shaped slice 1100 can be transformed (or “stretched”) into a rectangular color model 1102. In some examples, this new rectangular color model can be used for each query color. For example, the query color has a hue=0. However, the origin of the rectangular model shifts based on the hue angle of the query color. For example, if the hue angle of the query color is pi/2 (180 degrees) and the t (hue tolerance is set to pi/4, then the origin is set to pi/2 and largest hue value in the negative x direction=pi/2−pi/4=pi/4 and the largest hue value in the positive x direction=pi/2+pi/4=(3*pi)/4 The pie shaped-slice 1100 can be stretched into a rectangle where saturation approaches 0:

$${lim}_{s -> 0}$$

(assuming that saturation is measured from 0 to 1). This allows the design system 102 to use the arc length formula to measure the distance using the cartesian coordinate system.

For the hue circle, we can assume the distance in the hue circle from

$$( hue = 0 , {lim}_{s -> 0} )$$

to (hue=0, s=1) (called line segment 1) is the same as the line segment 2 as defined as distance from

$$( hue = 90 degrees , {lim}_{s -> 0} )$$

to (hue=90 degrees, s=1). Working within this right top quadrant of the hue circle, the line segment 2 can be shifted to map the coordinates to the x and y axis, where the y axis is the saturation and the x axis is the hue angle (where hue angles are limited to be within a given tolerence). The point at

$$( hue = 90 degrees , {lim}_{s -> 0} )$$

can be shifted in the cartesian coordinate system to be

$$( ( pie / 2 , {lim}_{s -> 0} ) )$$

on the x-axis. Furthermore, (hue=90 degrees, s=1) polor coordinates can be shifted to ((pi/2, s=1)). The arc from the two points at S=1 can also be extended. A similar process can be used for the upper left quadrant of the hue circle. If it is assumed the hue tolerence t is set at positive pi/2 and negative pi/2 and for example the query hue angle=0, then the coordinates for the new rectangle are defined on the new axis from −pie/2 to pie/2 and the coordinates for the y axis are defined from

$${lim}_{s -> 0}$$

to s=1, In this new model every possible substended arc in has the same length as Alternatively, saturation can simply mapped to a y-axis and hue angle (within a the given tolerence) can be mapped to a x-axis where t is the tolerence along the positive and negative axis from the hue angle of the query color at H=0.

With the pie-shaped slice 1100 stretched into a rectangular model 1102, all hue angles regardless of the saturation (e.g., the radius measurement in the pie shape) are equal to the hue circumference, allowing an equal measurement method using the new “arc length.” The design system 102 can now measure the distance (d) from the QC to the RC using the Pythagorean Theorum:

d²=Δsᵢ²+Δhᵢ²→d=√Δsᵢ²+Δhᵢ²

Accordingly, using the example discussed above, the process \sqrt{Δsᵢ²+(Δhᵢ)²} can be evaluated to identify that the distance between all query colors (Green 1 and Green 2) and all result colors. In this example, the distance is shortest when using Green Color 1 as the query color, so green color 1 now acts as the only query color. In the case where there are multiple query colors, only a single H|S pair for the query is matched to a single H|S pair for the result, which helps to reduce duplication.

The design system 102 also calculates \sqrt{md(s_{q})²+(tₕ)²}, which is the largest possible distance between H|S pairs for each query color (QC) and result color (RC). FIG. 11B illustrates how the maximum distance can be calculated. The center point QC is the query color, while the result color RC is located in the upper right corner of the rectangular model 1106. The maximum distance can be calculated to either corner (t,1) or (t,0) (where

$${lim}_{s -> 0}$$

is assumes to be =0). The longest possible distance is used. In some examples, the maximum distance can be measured by identifying all possible result colors and determining the longest distance. However, this approach requires the initial retrieval of qualifying all qualifying result colors.

The example below uses a hypothetical largest distance. The design system evaluates md(s_{Q})=|0−s_{q}| to determine the first candidate value and md(s_{q})=|1−s_{q}| to determine the second candidate value. The larger of the two values is used for md(s_{q}) for each query color, as follows:

Green color 1: πH=hue, 0.75 saturation

In the case of multiple query colors, each query color uses separate maximum distance calculations where the QC is always centered in the diagram shown in FIG. 11B. Accordingly, green color 1: md(s_{q})=|0−0.75|=0.75, as it is the highest value.

With all variable values calculated, the design system 102 can evaluate the ranking process. An example calculation is as follows:

$$HR ( A ) = {lim}_{range ( {v}_{j} )} {lim}_{Δ h -> {t}_{h}} {lim}_{s -> 0} {\sum }_{i = 1}^{n} {W}_{i} {P}_{i} ( 1 - \frac{\sqrt{Δ {s}_{i}^{2} + {( Δ {h}_{i} )}^{2}}}{\sqrt{{md ( {s}_{q} )}^{2} + {( {t}_{h} )}^{2}}} )$$

$$HR ( A ) = {lim}_{range ( {v}_{j} )} {lim}_{Δ h -> {t}_{h}} {lim}_{s -> 0} {\sum }_{i = 1}^{n} {W}_{i} {P}_{i} ( 1 - \frac{\sqrt{{( {s}_{q} - {s}_{r} )}^{2} + {( {h}_{q} - {h}_{r} )}^{2}}}{\sqrt{{md ( {s}_{q} )}^{2} + {( {t}_{h} )}^{2}}} )$$

$$HR ( A ) = {lim}_{range ( 0.5 - 0.7 )} {lim}_{Δ h -> \pm \frac{π}{12}} {lim}_{s -> 0} \sum 1 * 0.6 ( 1 - \frac{\sqrt{{( 0.75 - 0.75 )}^{2} + {( π - π )}^{2}}}{\sqrt{{( 0.75 )}^{2} + {( \frac{π}{12} )}^{2}}} ) + 1 * 0.4 ( 1 - \frac{\sqrt{{( 0.75 - 0.6 )}^{2} + {( π - \frac{25 π}{24} )}^{2}}}{\sqrt{{( 0.75 )}^{2} + {( \frac{π}{12} )}^{2}}} )$$

This results in a final harmonize rank (HR) for the result product of HR(A)=0.6+0.251=0.851. Also note that the second result color is within the

$$\pm \frac{π}{12}$$

tolerance since

$$Δ {h}_{for result color 2} = π - \frac{25 π}{24} = - \frac{π}{24}$$

which is less than

$$- \frac{π}{12} .$$

As part of this evaluation, the design system 102 may exclude results that have a low harmonize rank.

In some examples, the design system 102 can weigh the importance of saturation vs hue in measurement calculations. f is a factor for setting the relative importance of h (hue) to s (saturation). The numerical value for each Δhₙ can be multiplied by this factor stretching the x-axis for measuring change on distance. For example, if a saturation range is from 0 to 1, if it is assumed that t (hue tolerance) is set to

$$\frac{π}{12} ,$$

and if it is assumed the intent is to make saturation and hue have equal importance, then f (factor) can just be set to the inverse of t (hue tolerance) or

$$f = \frac{1}{t} = \frac{12}{π} .$$

Thus, f*t=1. This adjustment makes the maximum distance of the possible measurable distance for both saturation and hue equal to 1=offering an equal impact on search results. It may also be used to increase the relative importance of t or s. An alternative method to using a factor is to simply find the best t setting for accurate results.

The scaling factor f can also be included in the ranking process, as follows:

$$HR ( A ) = {lim}_{range ( {v}_{j} )} {lim}_{Δ h -> {t}_{h}} {lim}_{s -> 0} {\sum }_{i = 1}^{n} {W}_{i} {P}_{i} ( 1 - \frac{\sqrt{{Δ {s}_{i}^{2} + ( ( f ) Δ {h}_{i} ) )}^{2}}}{\sqrt{{md ( {s}_{q} )}^{2} + {( ( f ) ( {t}_{h} ) )}^{2}}} )$$

Limit Wₙ as follows:
If Pₙ≦Wₙ, then Wₙ=1
If Pₙ>Wₙ, then WₙPₙ=Wₙ

In some examples, a simpler version of the ranking process can be used that uses hue as distance measurement and that filters matches by saturation ranges. The following equation may be used where hue may be the only factor for determining distance. In this case, the ranking process will only use H|S pairs that have a saturation that meets the range of saturations specified in the query. Thus, even if a hue within a H|S pair matches the hue tolerance (t) of the query but the saturation does not match, the design system 102 may not include this H|S pair in the calculations of n matches to the query.

$$HR ( A ) = {lim}_{range ( {s}_{k} )} {lim}_{range ( {v}_{j} )} {lim}_{Δ h -> {t}_{h}} {\sum }_{i = 1}^{n} {W}_{i} {P}_{i} ( 1 - \frac{Δ {h}_{i}}{{t}_{h}} )$$

The design system appends information to low probability results (1006). For example, the design system 102 may append low probability results with incomplete categorization and refinement options as the next set of results and follow method 1 or 2 for the remaining results. In this manner result can be grouped based ranking in the initial document query. Each group is re-ranked using one of the harmonize rank processes described herein. This technique can be repeated multiple times where a tolerance for harmonize rank and document search relevance are set for the first set of qualifying results and the process is repeated.

With the products ranked, the design system 102 can present a list of ranked products to the user 104, as shown in FIG. 6.

Instead of just measuring distances between H|S pairs, the following process can be used to measure actual colors using hue, saturation and value. This can be useful for image correlation searches, which are described below. This process assumes that the pie-shaped slice is transformed into a rectangular model (as described above) Accordingly, if depth is added to the rectangular model, a three dimensional box is created, where the depth of the model represents value. After the pie-shaped slice (which has been “cut out of” an HSV cylinder) has been transformed into a rectangular model, the resulting model is a 3D box where the Euclidean Measurement for measuring distances in 3D can be used. The process is as follows:

$$HR ( A ) = {lim}_{Δ h -> {t}_{h}} {lim}_{s -> 0} {\sum }_{i = 1}^{n} {W}_{i} {P}_{i} ( 1 - \frac{\sqrt{Δ {s}_{i}^{2} + {( Δ {h}_{i} )}^{2} + Δ {v}_{i}^{2}}}{\sqrt{{md ( {s}_{q} )}^{2} + {( {t}_{h} )}^{2} + {md ( {v}_{q} )}^{2}}} )$$

In some examples, the design system 102 can perform an image correlation query in order to substantially exactly match a color palette to an image. For example, when selecting a palette from among the candidate palettes, the user 104 can elect to perform an image correlation search. The palette can include neutral brown colors and may include neutral gray colors if they are not an image background color. Palettes include W (percentage for each H|S pair). When the image correlation query is selected by the user 104, W for each H|S pair is executed using the exact W for each W|H pair. This ensures an image correlation can be done at the query. In addition to Harmonize Rank where H|S pairs are the primary measurement, the specific color measurement process shown above may also be used for this step where the distance between query and result H|S pairs is measured using hue saturation and value.

The techniques described above can be used to provide ranked lists of products in a variety of industries. For example, the harmonize search methods can be used in any industry where color, color matching and color coordination is a part of a decision for purchasing or selecting a product, combination of products or a design. It can also be applied to more abstract applications like the art industry in assisting with paint color selection. Example market segments include home design and decorating, apparel, clothing, and apparel accessories, cosmetics, jewelry and watches, gardening, and landscaping and other aesthetic markets. The techniques above can be used to determine skin tones of a user or colors of one or more cosmetic products and to provide color palettes that can be used to select cosmetics that will complement the user's complexion or other cosmetic products. The techniques above can also be used to determine skin tones of a user or colors of one or more clothing items and to provide color palettes that can be used to select clothing that will complement the user's complexion or other clothing items.

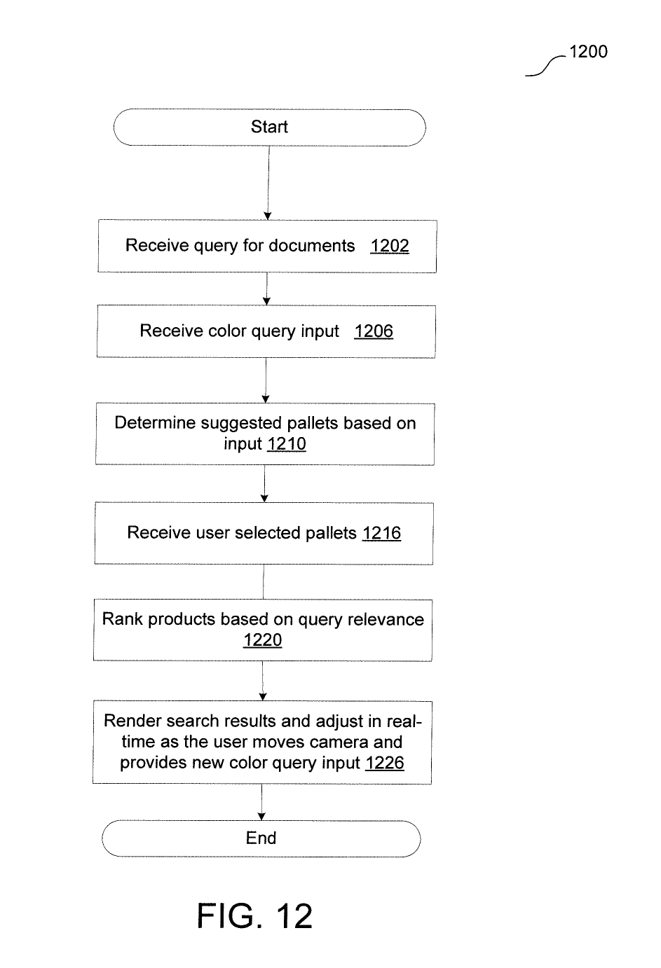

Referring to FIG. 12, techniques described herein may be used with mobile device and in real-time. For example search results presented to a user with a mobile device may be adjusted in real-time as the user moves a camera on the mobile device and provides new color query input.

Process 1200 receives query for documents from a user (1202). For example, a search engine starts with a set of all possible results in an index. The user may also choose a specific category or use a keyword search before selecting an image to match.

Process 1200 receives a color query input from a user (1206). For example, an initial photo input is received. For example, a user points the camera on their mobile device at desired objects to photograph and image is displayed on device. While the user is pointing the camera at the object, the system color corrects the photo by automatically detecting what type of light the user is currently in, such as outdoors, shade, incandescent, fluorescent, for example. Automatic adjustments include options like white balance, saturation, darkness/lightness, contrast and hue. Sliders, buttons and other controls also allow the user to manually make these adjustments while pointing at the object. Image data on a screen is sent to database in real-time for evaluation as user moves camera. For example, the images pixel information is sent in frames similar to a video camera and streamed to the database. An averaging process may be used here to reduce the amount of data streamed.

Process 1200 determines suggested pallets based on the user input (1210). Processing block 1210 may occur on a client or a server side. Processing block 1210 includes extracting HSV information for pixels in source images. For example, during this process the pixels in the image are extracted from the streamed images and mapped to HSV space where hue angles are measured in RYB space. This occurs for each image frame as it is received.

Processing block 1210 also includes parsing, identifying and grouping pixels by neutral gray, neutral brown & color and by H|S pairs for each group. For example, the pixels in the image are grouped in H|S pairs sent to a local database or server in real-time as the user moves the camera. Data for each H|S pair is sent in the following format: H|S|V|P, and other formats previously stated. This process happens for each image frame as it is received.

Processing block 1210 also includes sending information to database and/or index. For example, this occurs for each image frame as it is received. Early image data may be removed from the database as new images are streamed

Processing block 1210 also includes generating candidate palettes & query recipes. For example, color data is received from index or database, base hues are identified and suggested palettes and initial query settings, and associate rules for query modification are generated. This occurs for each image frame as it is received.

Processing block 1210 also includes ranking palettes using candidate palette as query and original query image(s) as result. For example, to rank the Complementary Green/Red Palette the system should first identify the relevant colors. Then the system adjusts P so the sum of all P is equal to 1.00. Harmonize Ranking Algorithms are identified to use. This occurs for each image frame as it is received.

Process 1200 receives user selected pallets for each image frame as it is received (1216). Process 1200 rank products based on query relevance (1220). For example, the system searches using a document query and color palette as a query. In one example, process 1200 parses an initial query and filters the results based on the initial query using categorization data and refinement options. Process 1200 ranks filtered results using the harmonize rank and appends low probability results with incomplete categorization and refinement options as the next set of results. The remaining results may be adjusted by parsing query and filter results based on the query using categorization data and refinement options and/or adjusted by ranking filtered results using harmonize rank. This occurs for each image frame as it is received.

Process 1200 renders search results and adjusts results in real-time as a user moves the camera and provides new color input (1226). The initial result is presented to the user on the screen of their device and new results are displayed with new streamed image data as the camera moves and new results are processed.

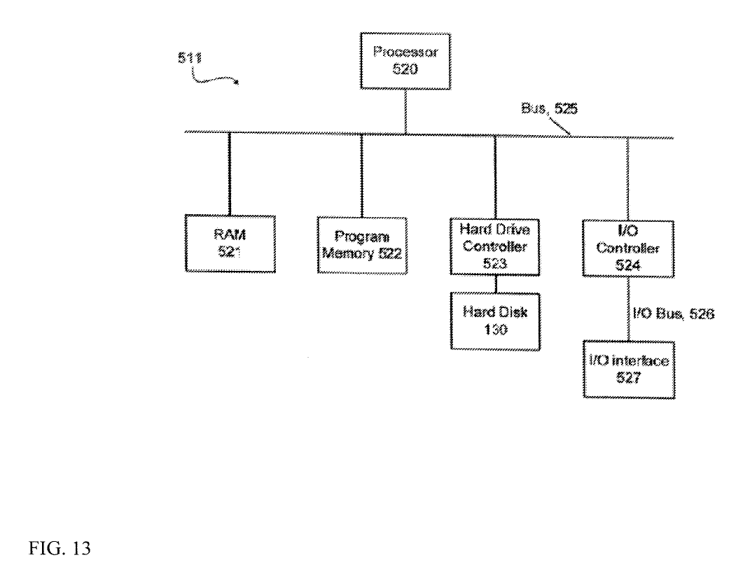

The systems, software, and methods described herein can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits). An example of one such type of computer is shown in FIG. 13, which shows a block diagram of a programmable processing system (system) 511 suitable for implementing or performing the apparatus or methods described herein. The system 511 includes a processor 520, a random access memory (RAM) 521, a program memory 522 (for example, a writeable read-only memory (ROM) such as a flash ROM), a hard drive controller 523, and an input/output (I/O) controller 524 coupled by a processor (CPU) bus 525. The system 511 can be preprogrammed, in ROM, for example, or it can be programmed (and reprogrammed) by loading a program from another source (for example, from a floppy disk, a CD-ROM, or another computer).

The hard drive controller 523 is coupled to a hard disk 130 suitable for storing executable computer programs, including programs embodying the present methods, and data including storage. The I/O controller 524 is coupled by an I/O bus 526 to an I/O interface 527. The I/O interface 527 receives and transmits data in analog or digital form over communication links such as a serial link, local area network, wireless link, and parallel link.

While the system and methods described above have been directed to an implementation of the home design tool for design and layout of rooms for a house, the tool is not limited to home designs, as such, other implementations are possible. For example, the home design tool could be used to generate a layout of an office building or other commercial space. In addition, the home design tool could be used to generate layouts of garden or other landscaping features.

Elements of different implementations described herein may be combined to form other implementations not specifically set forth above. The home design tool described above is not limited to home design layouts. For example, similar design tools can be used to produce, for example, exterior/landscaping layouts, factory equipment layouts, industrial and commercial layouts, clothing ensembles/outfits, office space layouts, restaurant layouts, and the like. Other implementations not specifically described herein are also within the scope of the following claims.

What is claimed is:

1. A method performed on a computing system, the method comprising:
receiving a first query for a product;
receiving an input that comprises a collection of colors;
determining, based at least in part on the input, one or more candidate color palettes;
presenting the one or more candidate color palettes on a web site;
receiving a selection that specifies one of the candidate color palettes as a selected color palette;
providing, on the web site, a list of products based at least in part on the first query and the selected color palette; and
adjusting the list of products in real-time as a user moves a camera on a mobile device and provides new color input.
